(19) United States
(12) Patent Application Publication
(10) Pub. No.: US 2003/0031161 A1
(43) Pub. Date: Feb. 13, 2003

(54) Uplink session extension

(76) Inventors: Robert W. Froehlich, McKinney, TX (US); Shridhar Krishnamurthy, Coppell, TX (US)

Correspondence Address: R. Scott Rhoades, Strasburger & Price, L.L.P., Suite 4300, 901 Main Street, Dallas, TX, 75202-3794, US

(21) Appl. No.: 10/213,660

(22) Filed: Aug. 7, 2002

Related U.S. Application Data
(60) Provisional application No. 60/310,600, filed on Aug. 7, 2001.

(51) Int. Cl. H04J 3/24

(52) U.S. Cl. 370/349; 370/338

(57) ABSTRACT

An apparatus and method for controlling a wireless terminal and a destination terminal with a wireless content switch in a wireless packet data network. The wireless content switch monitors data packets and acknowledgments transmitted to and from the wireless terminal and the destination terminal. The wireless content switch detects disruptions in the wireless packet data network and sends a transmission to the terminal remaining in communication with the wireless content switch to place the remaining terminal in a wait state. The wireless content switch then monitors and detects an improvement in the wireless packet data network. After the wireless content switch detects an improvement, the wireless content switch resumes the session, continuing transmission from the point which the disruption occurred.

### CROSS-REFERENCE TO RELATED APPLICATIONS

This application claims the priority benefit of U.S. Provisional Application for Patent, Serial No. 60/310,600, entitled “Uplink Session Extension,” filed on Aug. 7, 2001, which is hereby incorporated by reference for all purposes.

### STATEMENT REGARDING FEDERALLY SPONSORED RESEARCH/DEVELOPMENT

Not Applicable.

1. Field

The present invention relates to wireless data networks, and more particularly, to uplink session extension.

2. Background

Wireless packet data networks are designed with the assumption that the vast majority of the information flow is towards the wireless terminal, as opposed to transmissions from the wireless terminal. For example, pursuant to the General Packet Radio Services (GPRS) specification, only 25% of the channels are dedicated to transmission of data from the wireless terminal, while the remaining 75% of the channels are dedicated to transmission of data to the wireless terminal. Empirical studies have shown that in the case of individual, non-commercial users, 95% of the information flow is towards the wireless terminal.

However, the amount of data transmitted from wireless terminals by commercial users of wireless packet data networks is quickly growing. Empirical studies have shown that among commercial users, as much as 35% of the information flow is from the wireless terminal, as opposed to transmitted to the wireless terminal. As a result, the limited bandwidth allocated by the wireless packet data networks for data transmission from the wireless terminal becomes a limiting factor, and optimization of usage thereof becomes important.

Common examples of data transmission from the wireless terminal include file transfers, such as file transfer protocol (ftp) and electronic mail (e-mail), wherein a computer file at the wireless terminal is transmitted by the wireless terminal. Due to the size of most files, transmission is accomplished by breaking the file into segments, known as packets, and transmitting the packets separately in a sequence of transmissions over a period of time.

However, the lossy nature of the wireless air interface as well as the mobility of the wireless terminal results substantial throughput variance during the period of time when the packets are transmitted. During the time period, the wireless air interface can deteriorate to the point of zero throughput, causing an interruption in the transmission of the data packets from the wireless terminal to the destination.

Upon reestablishment, it is desirable to resume the sequential transmission of the data packets at the point where the interruption occurred, as opposed to restarting transmission from the beginning. Resuming transmission in the foregoing manner advantageously preserves network bandwidth.

Accordingly, where a sequential data packet transmission is interrupted and resumed, it would be desirable to resume the sequential transmission of the data packets over a wireless air interface at the point of the interruption.

### SUMMARY

An apparatus and method for controlling a wireless terminal and a destination terminal with a wireless content switch in a wireless packet data network. The wireless content switch monitors data packets and acknowledgments transmitted to and from the wireless terminal and the destination terminal. The wireless content switch detects disruptions in the wireless packet data network and sends a transmission to the terminal remaining in communication with the wireless content switch to place the remaining terminal in a wait state. The wireless content switch then monitors and detects an improvement in the wireless packet data network. After the wireless content switch detects an improvement, the wireless content switch resumes the session, continuing transmission from the point which the disruption occurred.

### BRIEF DESCRIPTION OF THE DRAWINGS

FIG. 1 is a block diagram of an exemplary communication system;

FIG. 2 is a block diagram of data for transmission from the wireless terminal to the destination terminal;

FIG. 3 is a signal flow diagram describing the transmission of data from a wireless terminal to a destination terminal;

FIG. 4 is a signal flow diagram describing the transmission of data from a wireless terminal to a destination terminal wherein no wireless terminal hold occurs;

FIG. 5 is a signal flow diagram describing the transmission of data from a wireless terminal to a destination terminal wherein a wireless terminal hold occurs; and

FIG. 6 is a signal flow diagram describing the caching of a data packet transmitted from the wireless terminal to a destination terminal.

### DETAILED DESCRIPTION OF THE DRAWINGS

Referring now to FIG. 1, there is illustrated a block diagram of an exemplary communication network, referenced generally by the numeric designation 100 which supports the Global System for Mobile Communications (GSM) specifications with General Packet Radio Service (GPRS) functionality, for transmitting data packets from a wireless terminal 105 to a destination terminal 110. The wireless terminal 105 is a mobile terminal generally associated with a user or subscriber to the communication network 100, and can comprise, but is not limited to a mobile station, a personal digital assistant, a computer, or a palm top computer capable of engaging in wireless data communications. Although the destination terminal 110 is illustrated connected to a wired network, it is noted that the destination terminal 110 can also comprise a mobile terminal.

Both the wireless terminal 105 and the destination terminal 110 communicate over a communication path which includes a wired network 115, which can comprise, for example, the internet. The wireless terminal 105 accesses the wired network 115 by means of a wireless network 120 which communications with the wireless terminal 105 over a wireless air interface.

The wireless network 120 is interfaced with the wired network 115 by any number of Gateway GPRS Support Nodes (GGSNs) 125. Each GGSN 125 is associated with any number of Internet Protocol (IP) addresses which the GGSN 125, in turn allocates to wireless terminals 105.

The wireless network 120 services to geographical areas which are divided into routing areas. Each routing area is associated with a particular Serving GPRS Support Node (SGSN) 130. Each SGSN 130 is associated with any number of base transceiver stations 135. The base transceiver stations 135 is the radio transceiver equipment which transmits and receives signals to and from the wireless terminal 105 over a wireless air interface 138.

The SGSNs 130 and the GGSNs 125 are interconnected by a backbone network 140. The backbone network routes packet data between the SGSNs 130 and the GGSNs 125 and can include a portion of the wired network 115. A wireless content switch (WCS) 145 is placed between the base transceiver stations 135 and the SGSN 130 and receives all signals passed therebetween. The foregoing signals permit the wireless content switch 145 to monitor the wireless air interface 138. Additionally, the wireless content switch 145 can cache data transmitted between the wireless terminal 105 and the destination terminal 110 and can inject signals to any part of the communication network 100. The wireless content switch is described in U.S. patent application Ser. No. 09/718,723 entitled “System and Method for Wireless Content Switch”, filed Nov. 22, 2000 and in U.S. patent application Ser. No. 09/839,830 entitled “System and Method for Wireless Packet Data Content Switch”, filed Apr. 19, 2001, both of which are hereby incorporated by reference for all purposes. The wireless content switch 145 includes a memory, a mass storage device, a processor and a communication device, all of which are not shown. The wireless content switch 145 further includes code to perform transmission monitoring, caching, session management and measurement of the wireless network's 120 quality. Specific details of the capabilities of the code and the wireless content switch 145 are disclosed herein.

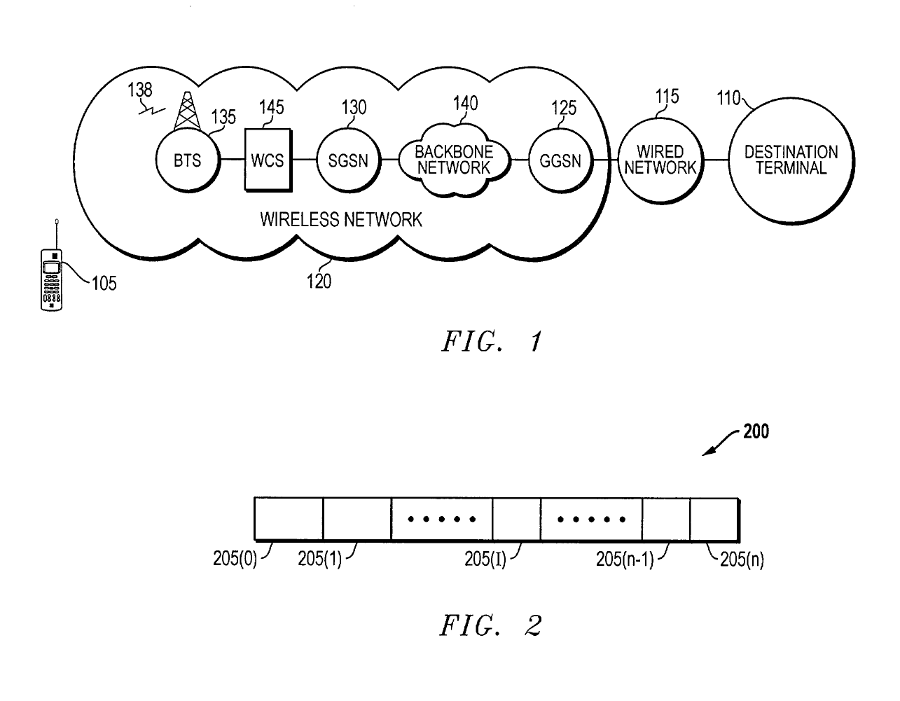

Referring now to FIG. 2, there is illustrated a block diagram of data 200 for transmission from the wireless terminal 105 to the destination terminal 110. Common examples of data transmission from the wireless terminal 105 to the destination terminal 110 include, but are not limited to, file transfers, wherein a computer file at the wireless terminal 105 is transmitted by the wireless terminal 105 to the destination terminal 110. Due to the size of most files, transmission is accomplished by breaking the file into sequential segments, known as packets 205(0) . . . 205(n), and transmitting the packets separately in a sequence of transmissions over a period of time.

However, the lossy nature of the wireless air interface 138 as well as the mobility of the wireless terminal 105 results in substantial throughput variance during the period of time when the packets 205 are transmitted. During the time period, the wireless air interface 138 can deteriorate to the point of zero throughput, causing an interruption in the transmission of the data packets 205 from the wireless terminal to the destination.

During a session where a sequence of data packets 205(1) . . . 205(n) are to be transmitted from the wireless terminal 105 to the destination terminal 110, where a deterioration occurs in the wireless air interface 138 which causes an interruption during transmission of data packet 205(I), the session is maintained. When conditions in the wireless air interface 138 improve, the session restarts by transmitting the packet beginning from packet 205(I) to the destination terminal 110, as opposed to transmitting packets beginning with packet 205(0)

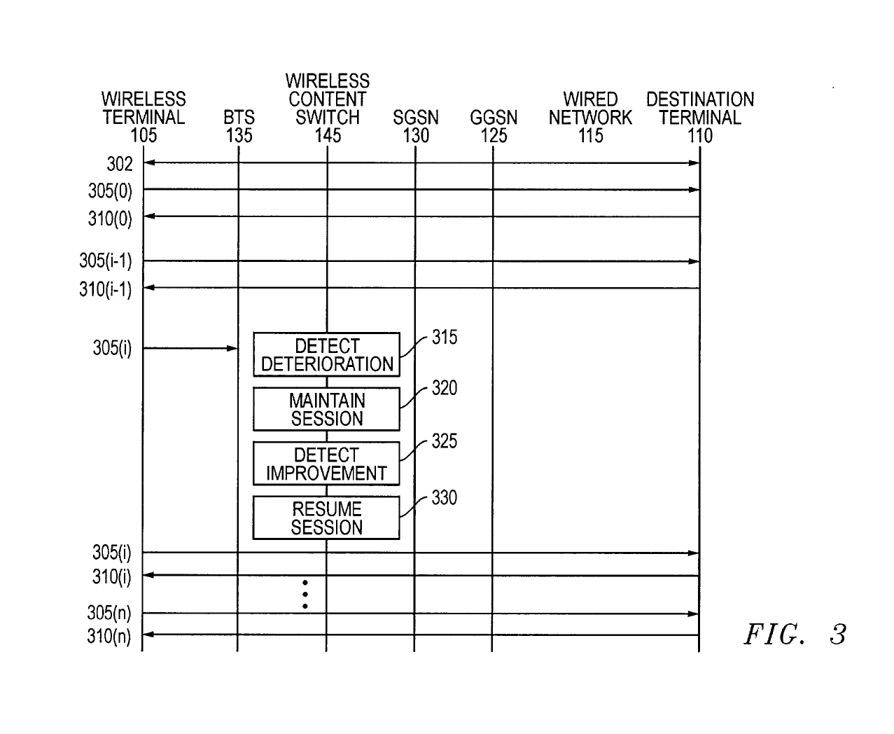

Referring now to FIG. 3, there is illustrated a signal flow diagram describing transmission of data from wireless terminal 105 to destination terminal 110. The transmission of data is commenced by a Transmission Control Session Synchronization procedure (signals 302). After the synchronization procedure 302, the wireless terminal 105 begins transmitting the data packets 205(0) . . . 205(i−1) (signals 305(0) . . . 305(i−1))

As each packet 205 is received at the destination terminal 110, the destination terminal 110 transmits an acknowledgment signal (signals 310(0) . . . signal 310(i−1)). In one embodiment, acknowledgement signals can be transmitted individually or multiple acknowledgements can be transmitted in a combined acknowledgement. However, immediately prior or during transmission of data packet 205(I) (signal 305(i)), a deterioration of the wireless air interface 138 occurs causing an interruption in the data transfer.

Responsive to the deterioration of the wireless air interface 138, the wireless content switch 145 detects the deterioration (action 315) . Detection of the deterioration of the wireless air interface 138 can be achieved by monitoring a number of signals transmitted between the base transceiver station 135 and the SGSN 130.

Responsive to detection of the deterioration (action 315), the wireless content switch 145 maintains the session between the wireless terminal 105 and the destination terminal 110 (action 320). The session can be maintained by transmission of signals to the destination terminal 110 and/or the wireless terminal 105 causing either or both of the foregoing to enter a waiting state.

When the wireless air interface conditions improve the wireless content switch 145 detects the improvement (action 325) and resumes the session (action 330). The session resumption by the wireless content switch 145 can include the transmission of signal(s) to the destination terminal 110 and/or the wireless terminal 105. The foregoing causes the wireless terminal 105 to continue transmitting the data, starting at data packet 205(I) (signal 305(i)) until data packet 205(n) (signal 305(n)).

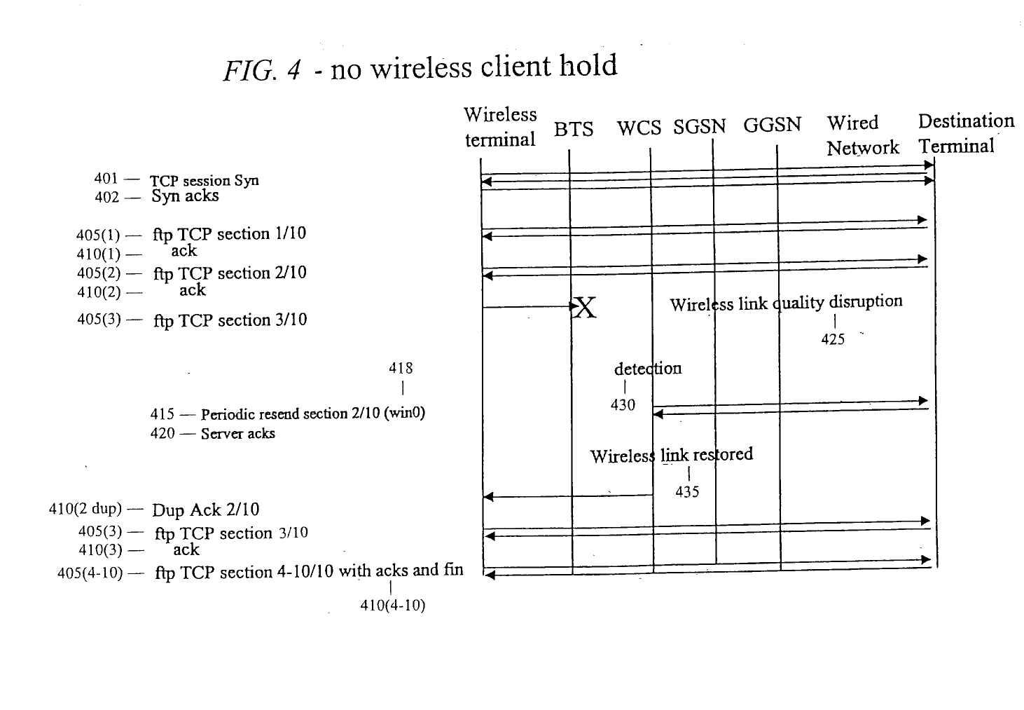

FIG. 4 is exemplary of data transmissions in scenarios wherein the no wireless terminal hold occurs. The transmission of data is commenced by a TCP Session Synchronization procedure (signals 401 and 402). After the synchronization procedure, the wireless terminal 105 begins transmitting the file transfer protocol (ftp) TCP sections 405(1). An acknowledgment 410(1) of receipt by the destination terminal 110 of the section 405(1) is then sent in response. The wireless terminal 105 continues sending the sections in numeric order. After the section 405(2) has been sent and acknowledged 410(2), section 405(3) is sent. However, prior to reception by the destination terminal 110, the wireless link quality is disrupted 425. The wireless content switch 145 detects this deterioration 430 and responds by resending the last acknowledged section 415, section 405(2) and by setting the TCP window size to zero (0) 418. The destination terminal 110 sends a duplicate acknowledgement 420 and maintains the session even though no TCP sections are being received. The receipt of the TCP window size set to zero 418 places the destination terminal 110 in a wait state. Once the wireless link is restored 435, the wireless content switch 145 transmits the duplicate acknowledgement 410(2 dup) to the wireless terminal 105. The wireless terminal then retransmits any packet that has not received an acknowledgement. In this scenario, the section 405(3) is retransmitted. The destination terminal 110, upon receipt of the section 405(3) transmits an acknowledgement 410(3). The remaining sections 405(4-10) and the corresponding acknowledgements 410(4-10) are sent and received. The resumption of the transmissions occurs at the point of disruption and does not require a retransmission of all sections.

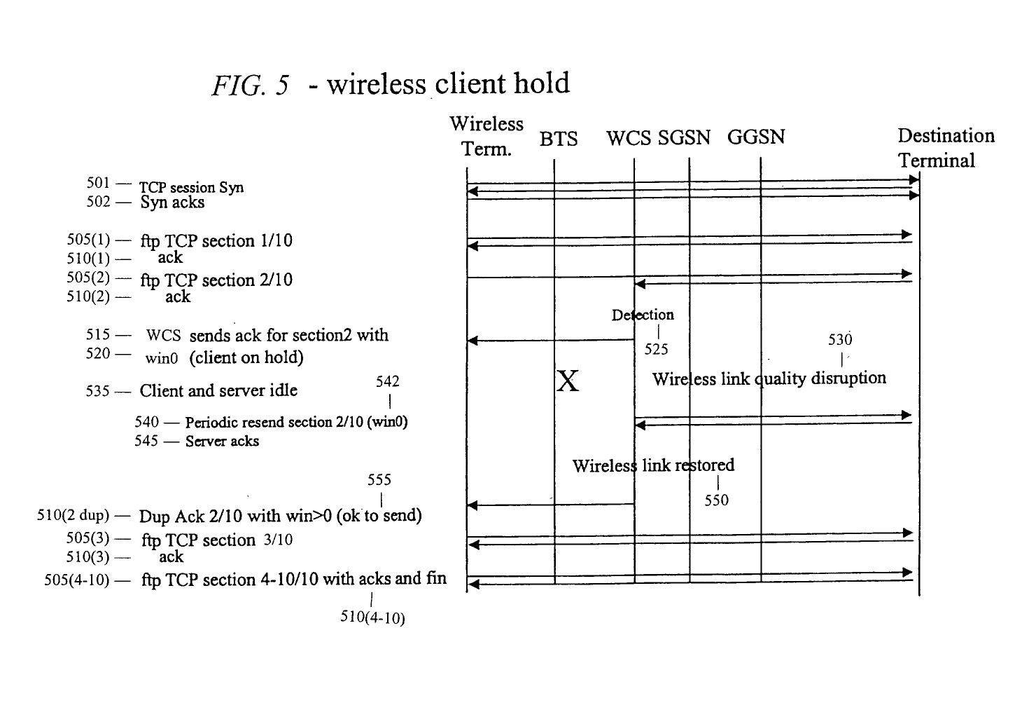

FIG. 5 is exemplary of data transmissions in scenarios wherein a wireless terminal hold occurs. The transmission of data is commenced by a TCP Session Synchronization procedure (signals 501 and 502). After the synchronization procedure, the wireless terminal 105 begins transmitting the file transfer protocol (ftp) TCP sections 505(1). An acknowledgment 510(1) of receipt by the destination terminal 110 of the section 505(1) is then sent in response. The wireless terminal 105 continues sending the sections in numeric order. After the section 505(2) has been received and acknowledgement 510(2) is sent, a disruption of the wireless link quality 530 is detected 525. The wireless content switch 145 detects this disruption 525 and responds by sending to the wireless terminal 105 the acknowledgement 515 with the TCP window size set to zero (0) 520. The receipt of the TCP window size set to zero 520 places the wireless terminal 105 in a wait state. The wireless content switch then sends to the destination terminal the last acknowledged section, section 505(2) and sets the TCP window size to zero (0) 542, placing the destination in a wait state. The wireless terminal 105 and the destination terminal maintain the session even though no TCP sections are being sent. The wireless content switch 145 periodically resends the last transmitted section 540, section 505(2) to the destination terminal 110. The destination terminal 110 responds with duplicate acknowledgements 545. Once the wireless link is restored 550, the wireless content switch 145 transmits the duplicate acknowledgement 510(2 dup) to the wireless terminal 105 and sets the TCP window size to a value greater than zero 555. The setting of the TCP window size to a value greater than zero 555 alerts the wireless terminal 105 that it is OK to send the remaining sections. The wireless terminal then retransmits any packet that has not received an acknowledgement. In this scenario, the section 505(3) is retransmitted. The destination terminal 110, upon receipt of the section 505(3) transmits an acknowledgement 510(3). The remaining sections 505(4-10) and the corresponding acknowledgements 510(4-10) are sent and received. The resumption of the transmissions occurs at the point of disruption and does not require a retransmission of all sections.

The scenarios of FIGS. 4 and 5 are exemplary and may be implemented using various signals as triggers for entering and exiting the wait states. An exemplary list of such signals are provided in Table 2, herein.

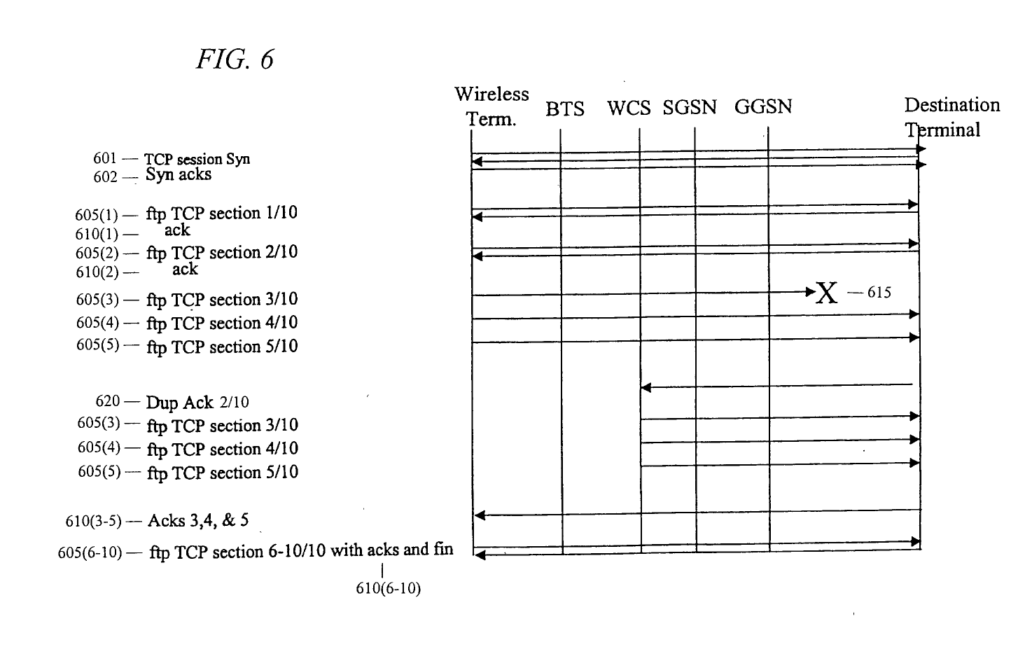

FIG. 6 is exemplary of a scenario wherein a data packet is lost over either the wireless network 120 or the wired network 115. The transmission of data is commenced by a TCP Session Synchronization procedure (signals 601 and 602). After the synchronization procedure, the wireless terminal 105 begins transmitting the file transfer protocol (ftp) TCP sections 605(1). The wireless content switch 145 caches the section data packets 605 before sending these packets to the destination terminal 110, providing a copy of the packets in the wireless content switch 145. The wireless content switch caches these packets until an acknowledgment has been received from the destination terminal 110. The wireless content switch 145 also caches acknowledgments until the next packet in order has been sent from the wireless terminal 105. An acknowledgment 610(1) of receipt by the destination terminal 110 of the section 605(1) is then sent in response. The wireless terminal 105 continues sending the sections in numeric order. Section 605(2) then sent and acknowledgement 610(2) is received by the wireless terminal 105. Section 605(3) is then sent. However, due to a disruption in either the wireless network 120 or the wired network 115, the destination terminal 110 fails to receive section 605(3). The wireless content switch 145 caches this section 605(3) and the later transmissions of sections 605(4 and 5). Sections 605(4 and 5) are received by the destination terminal 110, but section 605(3) is not received. When the destination terminal 110 receives the packets out of order, the destination terminal 110 sends a duplicate acknowledgment 620 of the last received section 605(2). When the wireless content switch 145 receives the duplicate acknowledgment 620, the wireless content switch 145 resends all sections subsequent to the last received section, sections 605(3-5) to the destination terminal 110. The destination terminal 110 sends acknowledgments 610(3-5) to the sections 605(3-5). The remaining sections 605(6-10) and the corresponding acknowledgements 610(6-10) are sent and received. The resumption of the transmissions occurs at the point of disruption and does not require a retransmission of all sections.

Examples of signals which the wireless content switch 145 monitors to detect deterioration (e.g., action 315) and improvement (e.g., action 325) in the wireless air interface conditions are listed in TABLE 1. It is noted that TABLE 1 is exemplary but is not exhaustive or limiting.

Examples of actions and signals which the wireless content switch 145 can take or send to either maintain the session (e.g., action 320) or resume the session (e.g., action 330) are listed in TABLE 2. TABLE 2 is exemplary but is not exhaustive or limiting.

### TABLE 1

Monitor wireless link quality of Gb (Layers 2-4); obtain either specific message or calculate mean/variance of Round Trip Timers (wireless client and server) to audit wireless terminal conditions

### Examples—GPRS Gb interface

L2—Network Service (e.g. Frame Relay)

Data Link Connection Indentifier (DLCI)

Forward Error Correction (FECN)

Backward Error Correction (BECN)

Command/Response bit (C/R)

Discard Eligibility (DE)

Network Service Virtual Circuit (NS-VC) quality with cause codes

L3—Base Station System GPRS Protocol (BSSGP)

BSSGP Virtual Circuit Indentifier (BVCI) blocking

BVCI cause codes

BSSGP radio status codes

RF Flow Control messaging (bucket size, leak rate, . . . ) for the terminal or cell/area

L4—Link Layer Control (LLC)

Packet drop by Base Station System (BSS)

Mobile states (suspend/resume)

Mobile negotiated or modified Quality of Service (QoS) attributes

TCP/IP header (with timestamps)

Calculate bandwidth control product (bandwidth*Return Trip Time (RTT))

Link Layer Control (LLC) discards

TABLE 2

| Action Desired | Wireless Client or Terminal | Landline/Wireless Server or Terminal |
|---|---|---|
| Delay Transmission | | |
| Negotiate Maximum Segment | Intercept SYN ACK from server and | Intercept SYN ACK from client and |
| Size (MSS) | degrade MSS | degrade MSS; MSS can be restored or |
| | | increased subsequently |
| Manage ACK response flag | | Sense delay ACKs from server and |
| | | use TCP to turn on delay flag (If |
| | | server has data to send client; this |
| | | saves wireless bandwidth) |
| Manage Congestion Window | Intercept server TCP segment and | Intercept client TCP segment and |
| (cwnd) | decrease cwnd; client will send less | increase cwnd; server will send less |
| | data | data |
| Manage slow start threshold | Intercept server TCP segment and | Intercept client TCP segment and |
| (ssthresh) | decrease ssthresh; client slows down | decrease ssthresh server slow down |
| | segment increase rate; subsequently | segment increase rate; subsequently |
| | increase ssthresh | increase ssthresh |
| Accelerate Transmissions | | |
| Manage ACK response flag | | Sense delay ACKs from server and |
| | | use TCP to turn on delay flag (this |
| | | may speed client transmissions) |
| Manage TCP window size | Intercept server TCP segment and | Intercept client TCP segment and |
| | increase TCP window size; client | increase TCP window size; server will |
| | will send larger segment sizes | send larger segment sizes |
| Manage Congestion Window | Intercept server TCP segment and | Intercept client TCP segment and |
| (cwnd) | increase cwnd; client will send more | increase cwnd; server will send more |
| | data | data |
| Manage Urgent Mode | Set urgent mode pointer (URG); | Set urgent mode pointer (URG); server |
| | client application may process faster | application may process faster and |
| | and clear buffers | clear buffers |
| Suspend Transmissions, Keep | | |
| Session Open | | |
| Manage TCP window size | Intercept server TCP segment and set | Intercept client TCP segment and set |
| | TCP window size to “0”; client will | TCP window size to “0”; server will |
| | wait for size to be > “0” before | wait for size to be > “0” before |
| | sending data | sending data |
| Manage TCP persist timer | Server sends “window probe” | Client sends “window probe” |
| | messages to client to see if window | messages to server to see if window |
| | size is > “0”; CASP response with | size is > “0”; CASP response with |
| | window size “0” (if wireless link is | window size “0” (if server link is |
| | down) | down) |
| Manage application ‘keep alive’ | Server sends “hello” messages to | Client sends “hello” messages to |
| timers (e.g. Telnet) | client to see if application is up; | server to see if application is up; |
| | CASP responds with a proper | CASP responds with a proper message |
| | message (if wireless link is down) | (if wireless link is down) |
| Improve Bandwidth | | |
| Manage half open sessions (e.g. | Sense duplicate open Telnet ports | Sense duplicate open Telnet ports |
| multiple Telnet instances) | (including timestamps) and close all | (including timestamps) and close all |
| | but the last one | but the last one |
| Manage ACK response flag | | Sense Delay ACKs from server and |
| | | use TCP to turn on delay flag (If |
| | | server has data to send client, this |
| | | saves wireless bandwidth) |

What is claimed is:

1. A method for controlling a wireless terminal and a destination terminal with a wireless content switch in a wireless packet data network, said method comprising:
monitoring data packets and acknowledgments transmitted to and from the wireless terminal and the destination terminal;
detecting conditions indicative of a disruption in the wireless packet data network, wherein one of the terminals remains in communication with the wireless content switch;
sending a first transmission to the terminal remaining in communication, wherein the first transmission places the terminal in a wait state;
detecting conditions indicative of an improvement in the wireless packet data network, wherein both of the terminals are in communication with the wireless content switch; and
sending a second transmission to the terminal in the wait state, wherein the second transmission resumes the session and wherein the transmission continue from the point of disruption.

2. The method of claim 1, wherein the step of monitoring data packets and acknowledgments includes caching data packets and acknowledgments.

3. The method of claim 1, wherein the steps of detecting conditions indicative of a disruption or an improvement include detecting conditions indicative of a disruption or improvement of a wireless air interface.

4. The method of claim 3, wherein the steps of detecting conditions indicative of a disruption or improvement of the wireless air interface includes measuring wireless link quality.

5. The method of claim 4, wherein the step of measuring wireless link quality includes evaluating at least one of the following:
DLCI;
Forward Error Correction;
Backward Error Correction;
C/R;
Discard Eligibility;
Network Services Virtual Circuit quality;
BVCI blocking;
BVCI cause codes;
BSSGP radio status codes;
RF Flow Control messaging;
Packet drop by BSS;
Mobile states;
Mobile negotiated or modified QOS attributes;
Link Layer Control discards;
TCP/IP header with timestamps; and
Bandwidth control product.

6. The method of claim 1, wherein the steps of detecting conditions indicative of a disruption or improvement include detecting conditions indicative of a disruption or improvement of a wired network.

7. The method of claim 6, wherein the steps of detecting conditions indicative of a disruption or improvement of the wired network includes measuring wired network quality.

8. The method of claim 7, wherein the step of measuring wired network quality includes evaluating at least one of the following:
DLCI;
Forward Error Correction;
Backward Error Correction;
C/R;
Discard Eligibility;
Network Services Virtual Circuit quality;
BVCI blocking;
BVCI cause codes;
BSSGP radio status codes;
RF Flow Control messaging;
Packet drop by BSS;
Mobile states;
Mobile negotiated or modified QOS attributes;
Link Layer Control discards;
TCP/IP header with timestamps; and
Bandwidth control product.

9. The method of claim 1, wherein the steps of sending first and second transmissions include performing at least one of the following:
degrading MSS;
restoring MSS
turning on delay flag;
decreasing congestion window;
increasing congestion window;
decreasing slow start threshold;
increasing slow start threshold;
setting window size to zero
setting window size to a non-zero number;
increasing window size;
setting urgent mode pointer;
dropping retransmitted or duplicate packets;
caching packets or control messages;
responding with below suitable threshold;
responding with link is down; and
closing all open Telnet ports except last open port.

10. A wireless content switch for use in a wireless packet data network, the wireless content switch comprising:
a processor;
a memory coupled to the processor;
a communication device coupled to the processor and the memory, the communication device for receiving and transmitting signals between a wireless terminal and a destination terminal; and
a mass storage device coupled to the memory and the processor, the mass storage device for storing management code;
the management code, when executed, performing the steps of:
monitoring transmission between the wireless terminal and the destination terminal, wherein the wireless content switch is communicating with the wireless terminal and destination terminal, wherein the transmissions form a session between the wireless terminal and the destination terminal;
monitoring the quality of the wireless packet data network;
detecting a disruption of the wireless packet data network, wherein communication continues with one of the terminals;
maintaining the session between the wireless terminal and the destination terminal by placing the terminal remaining in communication with the wireless content switch in a wait state;
detecting an improvement in the wireless network, wherein the improvement allows communication with the wireless terminal and the destination terminal;
resuming the session between the wireless terminal and the destination terminal, wherein the transmissions continue from the point of disruption.

11. The wireless content switch of claim 10, wherein the step of monitoring transmissions between the wireless terminal and the destination terminal includes monitoring data packets and acknowledgements transmitted between the wireless terminal and the destination terminal.

12. The wireless content switch of claim 11, wherein the step of monitoring data packets and acknowledgements includes caching data packets and acknowledgements.

13. The wireless content switch of claim 10, wherein the steps of detecting a disruption or an improvement in the wireless packet data network include detecting a disruption or improvement in a wireless air interface.

14. The wireless content switch of claim 10, wherein the steps of detecting a disruption or an improvement in the wireless packet data network include determining the link quality.

15. The wireless content switch of claim 14, wherein the step of determining the link quality includes evaluating at least one of the following:
DLCI;
Forward Error Correction;
Backward Error Correction;
C/R;
Discard Eligibility;
Network Services Virtual Circuit quality;
BVCI blocking;
BVCI cause codes;
BSSGP radio status codes;
RF Flow Control messaging;
Packet drop by BSS;
Mobile states;
Mobile negotiated or modified QOS attributes;
Link Layer Control discards;
TCP/IP header with timestamps; and
Bandwidth control product.

16. The wireless content switch of claim 10, wherein the steps of maintaining and resuming the session between the wireless terminal and the destination terminal include performing at least one of the follow:
degrading MSS;
restoring MSS
turning on delay flag;
decreasing congestion window;
increasing congestion window;
decreasing slow start threshold;
increasing slow start threshold;
setting window size to zero
setting window size to a non-zero number;
increasing window size;
setting urgent mode pointer;
dropping retransmitted or duplicate packets;
caching packets or control messages;
responding with below suitable threshold;
responding with link is down; and
close all open Telnet ports except last open port.

17. A method for reducing duplicative transmissions between a wireless terminal and a destination terminal in a wireless packet data network including a wireless content switch, the method comprising the steps of:
monitoring data packets and acknowledgments transmitted to and from the wireless terminal and the destination terminal;
detecting conditions indicative of a disruption in the wireless packet data network, wherein one of the terminals remains in communication with the wireless content switch;
receiving and caching transmissions from the terminal remaining in communication;
detecting conditions indicative of an improvement in the wireless packet data network, wherein both of the terminals are in communication with the wireless content switch; and
transmitting the cached transmissions received from the terminal that remained in communciation.

18. The method of claim 17, wherein the step of detecting conditions indicative of an improvement in the wireless packet data network includes receiving data packets and acknowledgements.

19. The method of claim 18, wherein the step of receiving data packets and acknowledgements includes receiving duplicate acknowledgements.

20. The method of claim 17, wherein the step of detecting conditions indicative of a disruption in the wireless packet data network include detecting conditions indicative of a disruption in the wired network.
